(19) United States
(12) Patent Application Publication
(10) Pub. No.: US 2007/0067850 A1
(43) Pub. Date: Mar. 22, 2007

(54) Multiple versions of electronic communications

(75) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/255,588

(22) Filed: Oct. 21, 2005

Related U.S. Application Data
(63) Continuation-in-part of application No. 11/233,402, filed on Sep. 21, 2005.
(63) Continuation-in-part of application No. 11/233,478, filed on Sep. 21, 2005.

(51) Int. Cl. H04N 7/16; G06F 17/00

(52) U.S. Cl. 726/26; 715/531

(57) ABSTRACT

In one aspect, a method related to electronic communications. In addition to the foregoing, other method and system and program product aspects are described in the claims, drawings, and text forming a part of the present application.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. Stephen G. Kunin, Benefit of Prior-Filed Application, USPTO Electronic Official Gazette, Mar. 18, 2003 at http://www.uspto.gov/web/offices/com/sol/og/2003/week11/patbene.htm. The present applicant entity has provided below a specific reference to the application(s) from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### RELATED APPLICATIONS

1. For purposes of the USPTO extra-statutory requirements, the present application constitutes a continuation in part of currently co-pending United States patent application entitled Reviewing Electronic Communications for Possible Restricted Content, naming Edward K. Y. Jung; Royce A. Levien; Robert W. Lord; Mark A. Malamud; and John D. Rinaldo, Jr. as inventors, U.S. application Ser. No. 11/233,402, filed on Sep. 21, 2005.

2. For purposes of the USPTO extra-statutory requirements, the present application constitutes a continuation in part of currently co-pending United States patent application entitled Identifying Possible Restricted Content in Electronic Communications, naming Edward K. Y. Jung; Royce A. Levien; Robert W. Lord; Mark A. Malamud; and John D. Rinaldo, Jr. as inventors, U.S. application Ser. No. 11/233,478, filed on Sep. 21, 2005.

### TECHNICAL FIELD

The present application relates, in general, to electronic communications.

### SUMMARY

In one aspect, a method related to electronic communications includes but is not limited to preparing an electronic communications text, wherein the electronic communications text includes at least one item of restricted content to be hidden from a first reader of the electronic communications text and not hidden from a second reader of the electronic communications text; and presenting the electronic communications text to the first reader and/or the second reader. In addition to the foregoing, other method aspects are described in the claims, drawings, and text forming a part of the present application.

In one aspect, a system related to electronic communications includes but is not limited to circuitry for preparing an electronic communications text, wherein the electronic communications text includes at least one item of restricted content to be hidden from a first reader of the electronic communications text and not hidden from a second reader of the electronic communications text; and circuitry for presenting the electronic communications text to the first reader and/or the second reader. In addition to the foregoing, other system aspects are described in the claims, drawings, and text forming a part of the present application.

In one or more various aspects, related systems include but are not limited to circuitry and/or programming and/or electro-mechanical devices and/or optical devices for effecting the herein-referenced method aspects; the circuitry and/or programming and/or electro-mechanical devices and/or optical devices can be virtually any combination of hardware, software, and/or firmware configured to effect the herein-referenced method aspects depending upon the design choices of the system designer skilled in the art.

In one aspect, a program product includes but is not limited to a signal bearing medium bearing one or more instructions for preparing an electronic communications text, wherein the electronic communications text includes at least one item of restricted content to be hidden from a first reader of the electronic communications text and not hidden from a second reader of the electronic communications text; and one or more instructions for presenting the electronic communications text to the first reader and/or the second reader. In addition to the foregoing, other program product aspects are described in the claims, drawings, and text forming a part of the present application.

In addition to the foregoing, various other method, system, and/or program product aspects are set forth and described in the teachings such as the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 depicts one implementation of an exemplary environment in which the methods and systems described herein may be represented;

FIG. 2 depicts a high-level logic flowchart of an operational process;

FIG. 3 shows several alternative implementations of the high-level logic flowchart of FIG. 2;

FIG. 4 shows several alternative implementations of the high-level logic flowchart of FIG. 3;

FIG. 5 shows several alternative implementations of the high-level logic flowchart of FIG. 4;

FIG. 6 shows several alternative implementations of the high-level logic flowchart of FIG. 4;

FIG. 7 shows several alternative implementations of the high-level logic flowchart of FIG. 4;

FIG. 8 shows several alternative implementations of the high-level logic flowchart of FIG. 3;

FIG. 9 shows several alternative implementations of the high-level logic flowchart of FIG. 2; and

FIG. 10 shows several alternative implementations of the high-level logic flowchart of FIG. 2.

The use of the same symbols in different drawings typically indicates similar or identical items.

### DETAILED DESCRIPTION

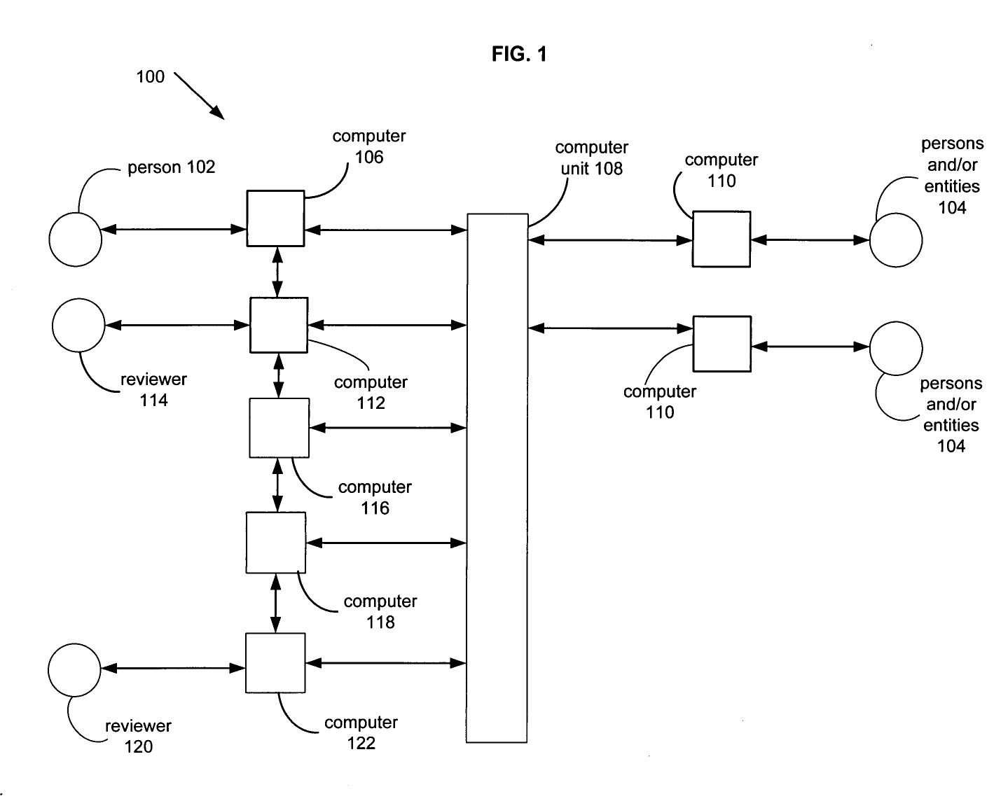

With reference to the figures, FIG. 1 depicts one implementation of an exemplary environment 100 in which the methods and systems described herein may be represented. A person 102 working for a business and/or an entity with a need to communicate with a person or persons who are members of the public or the media, customers, suppliers and/or other persons and/or entities 104 prepares a draft electronic communications text including language text and/or illustrations and/or graphics and/or audio data and/or attachments and/or links to other electronic files and/or to Internet-available resources, using a computer 106. The computer 106 may be a desktop computer or a laptop or another type of computer unit with which electronic communications may be prepared, and may be operably coupled to computing resources, here represented by computer unit 108, allowing access to the Internet. The draft form of the electronic communications text is designed to be posted to a weblog or other Internet communications forum, or included in email, that is accessible to the persons 104 via computers 110, which may be desktop computers or laptop or another type of computer unit with which electronic communications may be viewed, and are operably coupled to computing resources, here represented by computer unit 108, allowing access to the Internet. The draft form of the electronic communications text is accepted by software running on computer 106 and/or computer 112, where computer 112 is operably coupled to computer 106, so that it may be reviewed for at least one item of restricted content by a reviewer 114. The reviewer 114 represents one or more human reviewers and/or computing resources.

One or more existing electronic documents including language text and/or graphics and/or illustrations and/or audio files and/or attachments and/or links to other electronic files and/or to Internet-available resources, are stored on the computer 116, which represents one or more computers on which the existing electronic documents may be stored, and which may be operably coupled to computer 112. The computer 116 may be a desktop computer or a laptop or another type of computer unit with which the contents of existing electronic documents may be searched, and the computer 116 may be operably coupled to computing resources, here represented by computer unit 108, allowing access to the Internet. The contents, including attachments and/or linked files and/or linked Internet-available resources, of the one or more existing electronic files are available for searching, where the searching may be performed using computing resources associated with the computer 116 or with the computer 118, which represents one or more computers which may be used for such searching. The results of the search are available for review by reviewer 120, which represents one or more human reviewers and/or computing resources, so that they may be reviewed for at least one item of restricted content. The review performed by reviewer 120 may be performed using the computing resources of computer 122, which represents one of more computers which may be used for such review, and which is operably coupled to the computer 118. Any at least one item of restricted content that may be identified by the reviewer 120 serves as a basis for the review of the draft form of the electronic communications text reviewed by reviewer 114.

The person 102 may need to prepare alternate versions of an electronic communications text for different target readers, such that at least one item of restricted content is included in one version for, e.g., the board of directors of the entity for whom the person 102 works and/or the person 102 and/or the reviewer 114 and/or the reviewer 120 (e.g., in some instances readers can include preparers and/or reviewers), and is not included in another version for, e.g., a supplier of the entity for whom the person 102 works and/or for a member of the public and/or the reviewer 114 and/or the reviewer 120 (e.g., the reviewers 114 and 120 may have different levels of access to the electronic communications text). The person 102 may use computer 106 to prepare these alternate versions. Two or more alternate versions may be prepared. Items of restricted content not included in various versions may overlap in the sense that they include commons elements without coinciding completely. The person 102 may use computer 106 to demarcate the at least one item of restricted content. When one or more items of restricted content, each of which may be read by at least one intended reader, are demarcated in an electronic communications text, the items of restricted content and/or items of replacement material and/or replacement indicators which may be accessed and/or edited by one reader and not by another reader may be visible at the same time to the reader with access, and/or may be visible singly and/or in groups as commanded by the reader with access. The at least one item of restricted content may be replaced in a version by an item of replacement material that indicates the presence of an omission of material, or the electronic communications text may be edited to conceal the omission. The person 102 and the reviewer 114 may select a draft form of the electronic communications text using computers 106 and 112, where the draft form of the electronic communications text may be seen as the target reader will see it, or with the at least one item of restricted content indicated in a document from which it is excluded for a target reader, and/or with any items of replacement material or edits to conceal the exclusion of the at least one item of restricted content. The person 102 and the reviewer 114 may make changes to a draft form of the electronic communications text as part of the preparation process. After the electronic communications text has been made available to its target reader(s), the person 102 and the reviewer 114 may also select this final form of the electronic communications text using computers 106 and 112, where the final form of the electronic communications text may be seen as the target reader will see it, or with the an at least one item of restricted content indicated in a document from which it is excluded for a target reader, and/or with any items of replacement material or edits to conceal the exclusion of the at least one item of restricted content.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

Following is a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

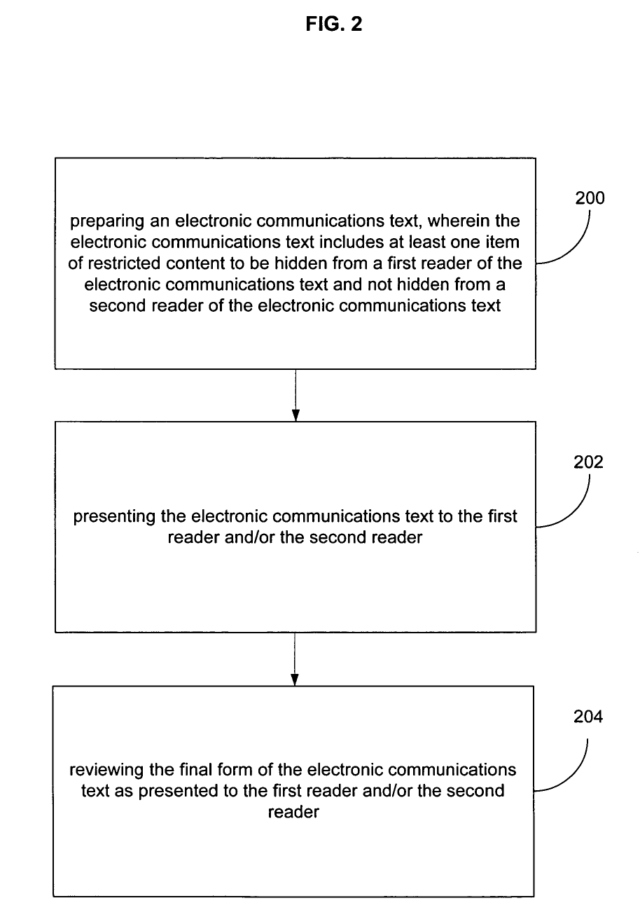

FIG. 2 depicts a high-level logic flowchart of an exemplary operational process. Operation 200 shows preparing an electronic communications text, wherein the electronic communications text includes at least one item of restricted content to be hidden from a first reader of the electronic communications text and not hidden from a second reader of the electronic communications text (e.g., preparing an electronic communications text, where the preparing is performed by the person 102 and/or the reviewer 114 using the hardware/software/firmware of computers 106 and/or 112, including a description of a trade secret to be hidden from a person 104, e.g., a supplier of the entity for whom the person 102 works and not hidden from another person 104, e.g., a member of the board of directors of the entity for whom the person 102 works). Operation 202 illustrates presenting the electronic communications text to the first reader and/or the second reader (e.g., presenting the electronic communications text to a person 104, e.g., a customer of of the entity for whom the person 102 works, and to another person, e.g., an officer of the entity for whom the person 102 works). The exemplary operational process of FIG. 2 may also include operation 204. Operation 204 depicts reviewing the final form of the electronic communications text as presented to the first reader and/or the second reader (e.g., reviewing an electronic communications text, where the reviewing is performed by the person 102 and/or the reviewer 114 using the hardware/software/firmware of computers 106 and/or 112, as presented to a person 104, e.g., a competitor of the entity for whom the person 102 works and not hidden from another person 104, e.g., a shareholder of the entity for whom the person 102 works).

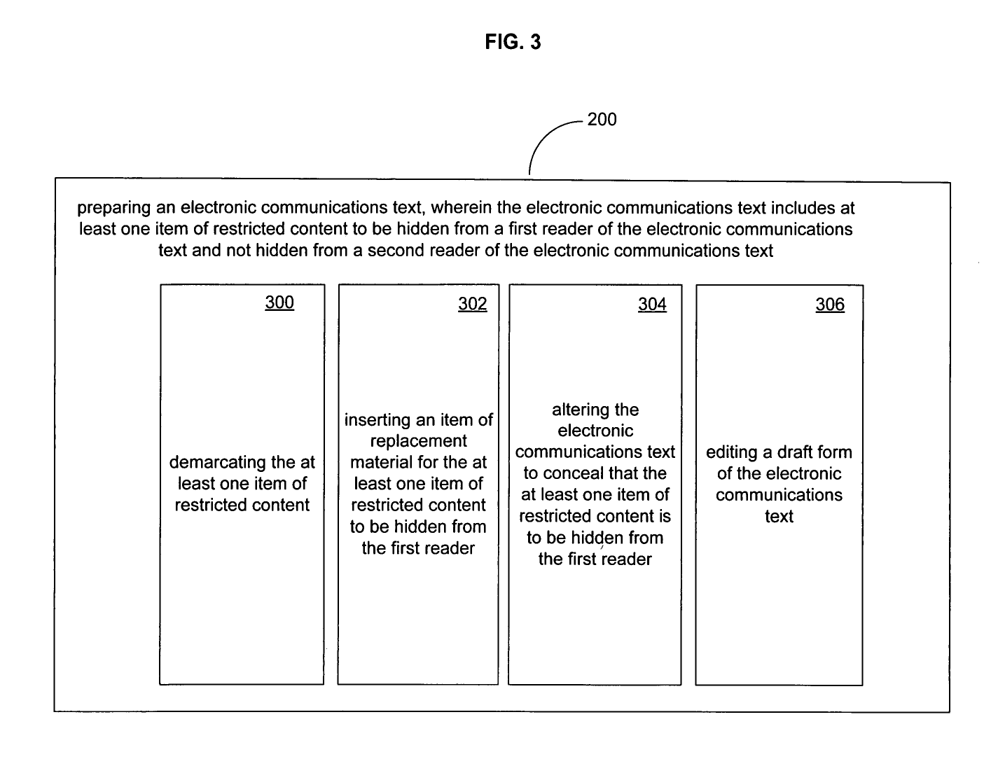

FIG. 3 shows several alternative implementations of the high-level logic flowchart of FIG. 2. Depicted is that operation 200—preparing an electronic communications text, wherein the electronic communications text includes at least one item of restricted content to be hidden from a first reader of the electronic communications text and not hidden from a second reader of the electronic communications text—may include one or more of the following operations: 300, 302, 304, and/or 306. Operation 300 shows demarcating the at least one item of restricted content (e.g., demarcating the at least one item of restricted content, where the demarcating is performed by the person 102 and/or the reviewer 114 using the hardware/software/firmware of computers 106 and/or 112, and the at least one item of restricted content is a name of a secret project under development). Operation 302 illustrates inserting an item of replacement material for the at least one item of restricted content to be hidden from the first reader (e.g., inserting an item of replacement material drawn from a database, where the insertion is performed automatically or by the person 102 and/or the reviewer 114 using the hardware/software/firmware of computers 106 and/or 112, to replace the embargoed specifications of a yet-to-be-relaesed product, such as “SPECIFICATIONS WITHHELD”). Operation 304 shows altering the electronic communications text to conceal that the at least one item of restricted content is to be hidden from the first reader (e.g., alteiring the electronic communications text, where the altering is performed by the person 102 and/or the reviewer 114 using the hardware/software/firmware of computers 106 and/or 112, to omit any reference to hidden material such as a list of potential targets in a lawsuit.). Operation 306 illustrates editing a draft form of the electronic communications text (e.g., editing a draft form of the electronic communications text, where the editing is performed by the person 102 and/or the reviewer 114 using the hardware/software/firmware of computers 106 and/or 112, to change previous decisions made about demarcating at least one item of restricted content, inserting an item of replacement material, and/or altering the draft form of the electronic communications text to conceal hiding of the at least one item of restricted content).

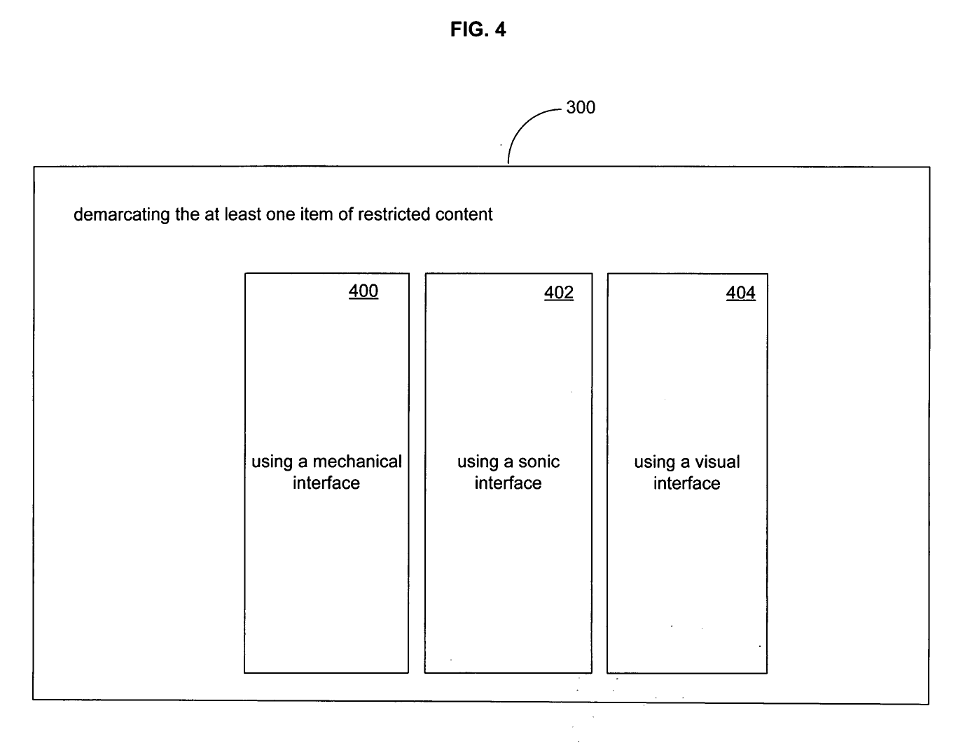

FIG. 4 shows several alternative implementations of the high-level logic flowchart of FIG. 3. Depicted is that operation 300—demarcating the at least one item of restricted content—may include one or more of the following operations: 400, 402, and/or 404. Operation 400 depicts using a mechanical interface (e.g., using an interface with tactile input receptor(s), where the tactile input receptors are used by the person 102 and/or the reviewer 114 using the hardware/software/firmware of computers 106 and/or 112, to demarcate the at least one item of restricted content by postioning a cursor on a visual display and inserting control characters in the electronic communications text). Operation 402 illustrates using a sonic interface (e.g., using a sonic interface, where the keyboard is used by the person 102 and/or the reviewer 114 using the hardware/software/firmware of computers 106 and/or 112, to demarcate the at least one item of restricted content by using oral commands such as “begin omission” and “end omission”). Operation 404 illustrates using a visual interface (e.g., using a visual interface, where the keyboard is used by the person 102 and/or the reviewer 114 using the hardware/software/firmware of computers 106 and/or 112, to demarcate the at least one item of restricted content by using visual clues such as highlighing).

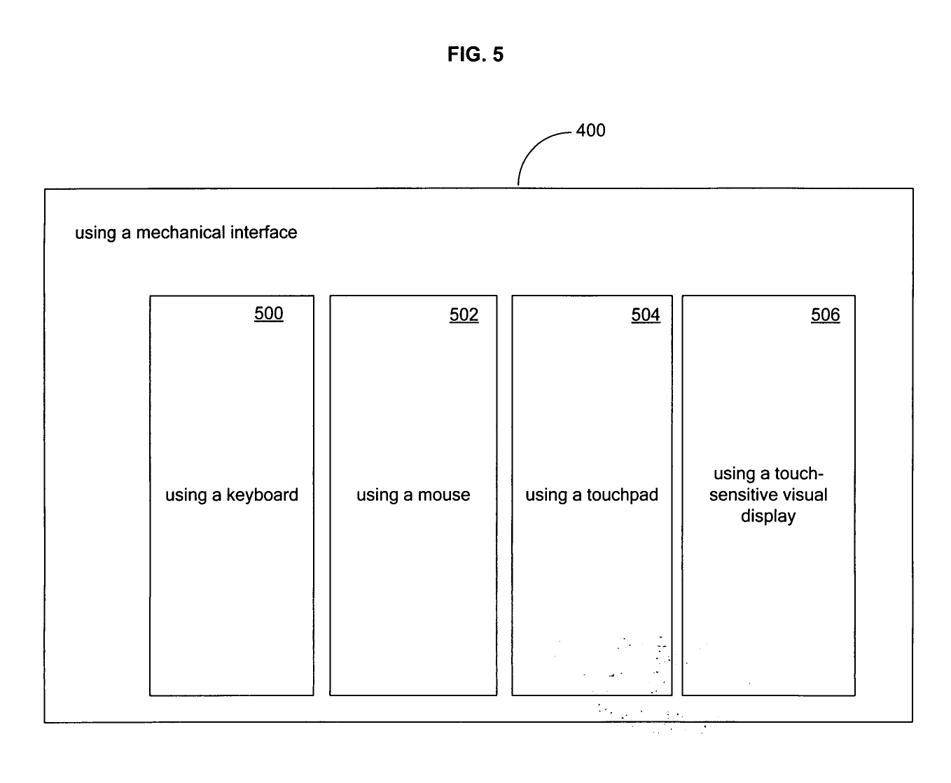

FIG. 5 shows several alternative implementations of the high-level logic flowchart of FIG. 4. Depicted is that operation 400—using a mechanical interface—may include one or more of the following operations: 500, 502, 504, and/or 506. Operation 500 illustrates using a keyboard (e.g., using a keyboard to demarcate the at least one item of restricted content, where the keyboard is used by the person 102 and/or the reviewer 114 using the hardware/software/firmware of computers 106 and/or 112). Operation 502 depicts using a mouse (e.g., using a mouse to demarcate the at least one item of restricted content, where the mouse is used by the person 102 and/or the reviewer 114 using the hardware/software/firmware of computers 106 and/or 112 to position a cursor on a visual display and insert visual indications in the electronic communications text). Operation 504 depicts using a touchpad (e.g., using a touchpad to demarcate the at least one item of restricted content, where the touchpad is used by the person 102 and/or the reviewer 114 using the hardware/software/firmware of computers 106 and/or 112 to position a cursor on a visual display and insert visual indications in the electronic communications text). Operation 506 shows using a touch-sensitive visual display (e.g., using a touch-sensitive visual display to demarcate the at least one item of restricted content, where the touch-sensitive visual display is used by the person 102 and/or the reviewer 114 using the hardware/software/firmware of computers 106 and/or 112 to position a cursor on a visual display and insert visual indications in the electronic communications text).

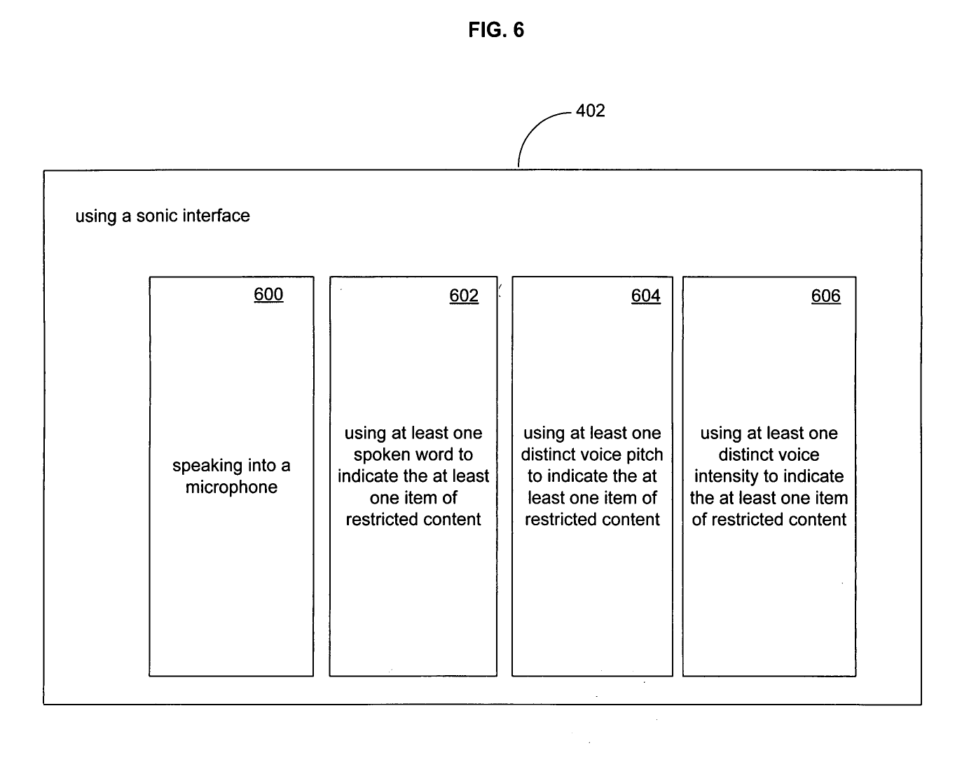

FIG. 6 shows several alternative implementations of the high-level logic flowchart of FIG. 4. Depicted is that operation 402—using a sonic interface—may include one or more of the following operations: 600, 602, 604, and/or 606.

Operation 600 illustrates speaking into a microphone (e.g., speaking into a microphone, where the speaking is performed by the person 102 and/or the reviewer 114 using the hardware/software/firmware of computers 106 and/or 112 to convey voice commands to demarcate the at least one item of restricted content). Operation 602 depicts using at least one spoken word to indicate the at least one item of restricted content (e.g., using at least one spoken word to indicate the at least one item of restricted content, where the speaking is performed by the person 102 and/or the reviewer 114 using the hardware/software/firmware of computers 106 and/or 112 to convey voice commands to demarcate the at least one item of restricted content, such as “hide [description of trade secret] end hide”). Operation 604 depicts using at least one distinct voice pitch to indicate the at least one item of restricted content (e.g., using at least one spoken word to indicate the at least one item of restricted content, where the speaking is performed by the person 102 and/or the reviewer 114 using the hardware/software/firmware of computers 106 and/or 112 to convey voice commands to demarcate the at least one item of restricted content, such as “hide [description of trade secret] end hide,” where the quoted words are spoken at a distinctly lower voice pitch than the words before and after the quoted words). Operation 606 shows using at least one distinct voice intensity to indicate the at least one item of restricted content (e.g., using at least one spoken word to indicate the at least one item of restricted content, where the speaking is performed by the person 102 and/or the reviewer 114 using the hardware/software/firmware of computers 106 and/or 112 to convey voice commands to demarcate the at least one item of restricted content, such as “hide [description of trade secret] end hide,” where the quoted words are spoken at a distinctly lower voice intensity than the words before and after the quoted words).

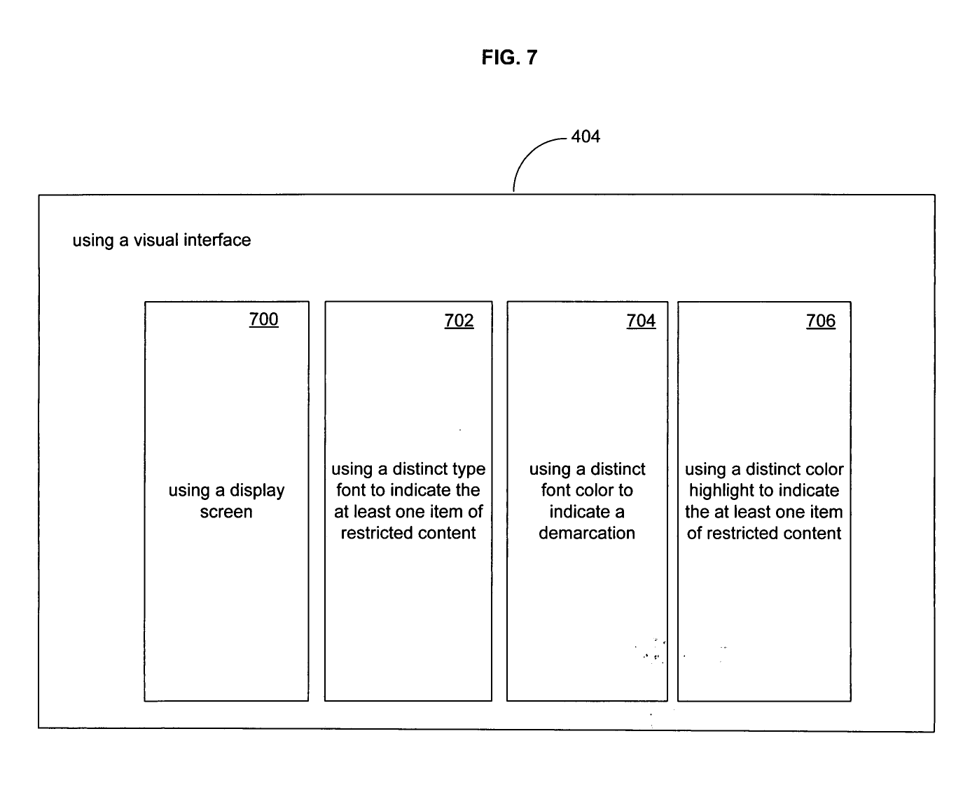

FIG. 7 shows several alternative implementations of the high-level logic flowchart of FIG. 4. Depicted is that operation 404—using a visual interface—may include one or more of the following operations: 700, 702, 704, and/or 706. Operation 700 illustrates using a display screen (e.g., using a display screen, where the use is performed by the person 102 and/or the reviewer 114 using the hardware/software/firmware of computers 106 and/or 112 to position a cursor on the visual display and insert visual indications in the electronic communications text). Operation 702 depicts using a distinct type font to indicate the at least one item of restricted content (e.g., using a distinct type font to indicate the at least one item of restricted content, where the use is performed by the person 102 and/or the reviewer 114 using the hardware/software/firmware of computers 106 and/or 112, such as using Arial type to indicate the at least one item of restricted content in a document that otherwise uses Times New Roman type). Operation 704 depicts using a distinct font color to indicate a demarcation (e.g., using a distinct font color to indicate a demarcation, where the use is performed by the person 102 and/or the reviewer 114 using the hardware/software/firmware of computers 106 and/or 112, such as using red type to indicate the at least one item of restricted content in a document that otherwise uses black type). Operation 706 shows using a distinct color highlight to indicate the at least one item of restricted content (e.g., using a distinct color highlight to indicate the at least one item of restricted content, where the use is performed by the person 102 and/or the reviewer 114 using the hardware/software/firmware of computers 106 and/or 112, such as using red highlighting to indicate the at least one item of restricted content in a document that otherwise uses no highlighting).

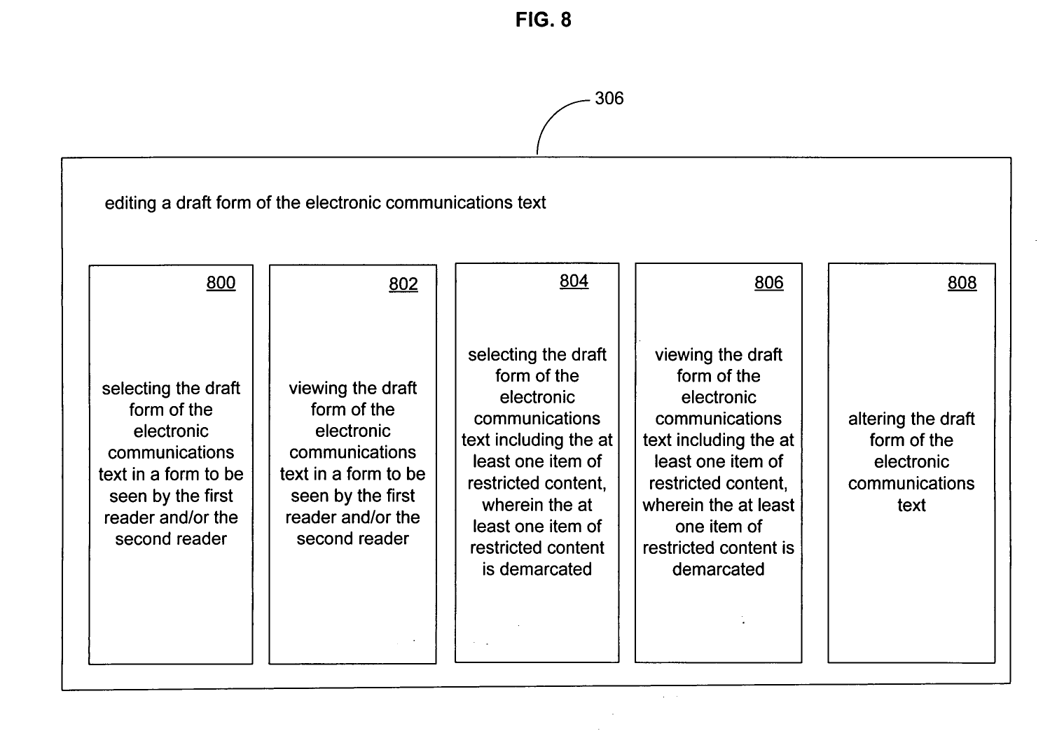

FIG. 8 shows several alternative implementations of the high-level logic flowchart of FIG. 4. Depicted is that operation 306—editing a draft form of the electronic communications text—may include one or more of the following operations: 800, 802, 804, 806 and/or 808. Operation 800 illustrates selecting the draft form of the electronic communications text in a form to be seen by the first reader and/or the second reader (e.g., selecting the draft form of the electronic communications text, where the selecting is performed by the person 102 and/or the reviewer 114 using the hardware/software/firmware of computers 106 and/or 112, in the form in which the target reader is intended to see it, by choosing an option from a menu). Operation 802 depicts viewing the draft form of the electronic communications text in a form to be seen by the first reader and/or the second reader (e.g., viewing the draft form of the electronic communications text, where the viewing is performed by the person 102 and/or the reviewer 114 using the hardware/software/firmware of computers 106 and/or 112, in the form in which the target reader is intended to see it, by choosing an option from a menu). Operation 804 depicts selecting the draft form of the electronic communications text including the at least one item of restricted content, wherein the at least one item of restricted content is demarcated (e.g., selecting the draft form of the electronic communications text, where the selecting is performed by the person 102 and/or the reviewer 114 using the hardware/software/firmware of computers 106 and/or 112, in the form in which the at least one item of restricted content which might otherwise be hidden is detectable to the person 102 and/or the reviewer 114, by choosing an option from a menu). Operation 806 shows viewing the draft form of the electronic communications text including the at least one item of restricted content, wherein the at least one item of restricted content is demarcated (e.g., viewing the draft form of the electronic communications text, where the viewing is performed by the person 102 and/or the reviewer 114 using the hardware/software/firmware of computers 106 and/or 112, in the form in which the at least one item of restricted content which might otherwise be hidden is detectable to the person 102 and/or the reviewer 114, by choosing an option from a menu). Operation 808 shows altering the draft form of the electronic communications text (e.g., altering the draft form of the electronic communications text, where the altering is performed by the person 102 and/or the reviewer 114 using the hardware/software/firmware of computers 106 and/or 112, by making a previously-selected at least one item of restricted content visible to a target reader and selecting another at least one item of restricted content to hide from the target reader).

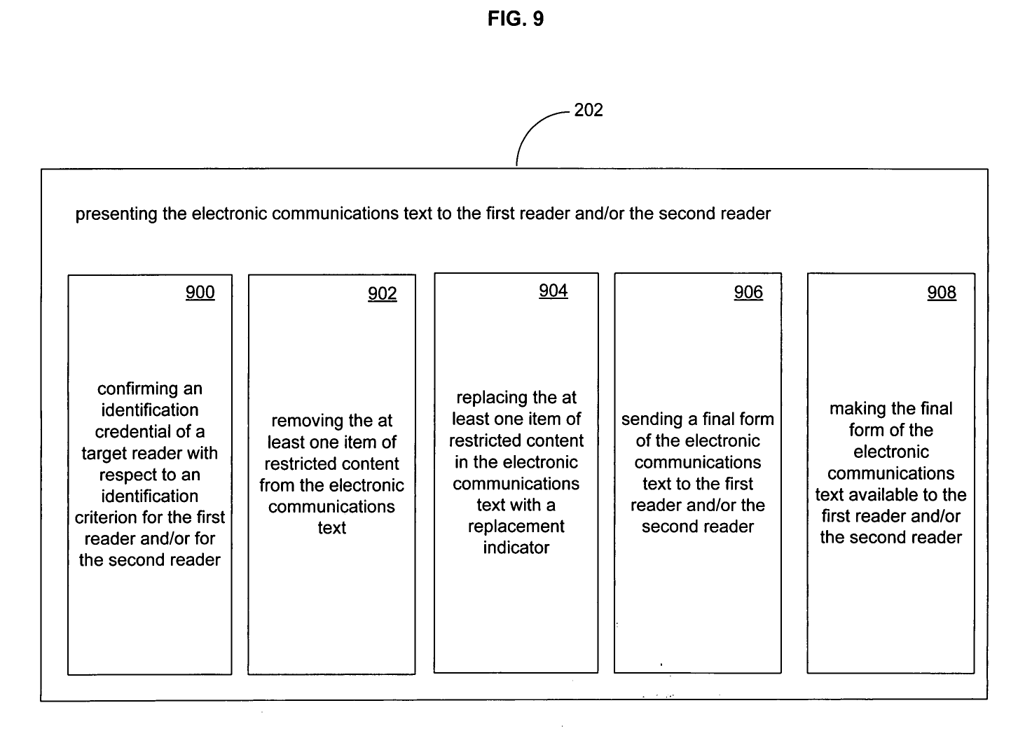

FIG. 9 shows several alternative implementations of the high-level logic flowchart of FIG. 2. Depicted is that operation 202—presenting the electronic communications text to the first reader and/or the second reader—may include one or more of the following operations: 900, 902, 904, 906 and/or 908.

Operation 900 illustrates confirming an identification credential of a target reader with respect to an identification criterion for the first reader and/or for the second reader (e.g., confirming an identification credential of a target reader with respect to an identification criterion for the first reader and/or for the second reader, where the first and second readers are persons 104, using the hardware/software/firmware of computers 106, 108, 112, 116, 118, and/or 122, to verify that a person 104 seeking access to an electronic communications text prepared for presentation to a board member is presenting the identification credentials assigned to board members). Operation 902 depicts removing the at least one item of restricted content from the electronic communications text (e.g., removing the at least one item of restricted content from the electronic communications text, using the hardware/software/firmware of computers 106, 108, 112, 116, 118, and/or 122, before presenting the electronic communications text to a reader, person 104). Operation 904 depicts replacing the at least one item of restricted content in the electronic communications text with a replacement indicator (e.g., replacing the at least one item of restricted content in the electronic communications text with a replacement indicator, using the hardware/software/firmware of computers 106, 108, 112, 116, 118, and/or 122, before presenting the electronic communications text to a reader, person 104). Operation 906 shows sending a final form of the electronic communications text to the first reader and/or the second reader (e.g., sending a final form of the electronic communications text to the first reader and/or the second reader, using the hardware/software/firmware of computers 104, 106, 108, 112, 116, 118, and/or 122, via an email, where the first and/or second readers are persons 104). Operation 908 shows making the final form of the electronic communications text available to the first reader and/or the second reader (e.g., making the final form of the electronic communications text available to the first reader and/or the second reader, using the hardware/software/firmware of computers 104, 106, 108, 112, 116, 118, and/or 122, by posting the electronic communications text to a weblog, where the first and/or second readers are persons 104).

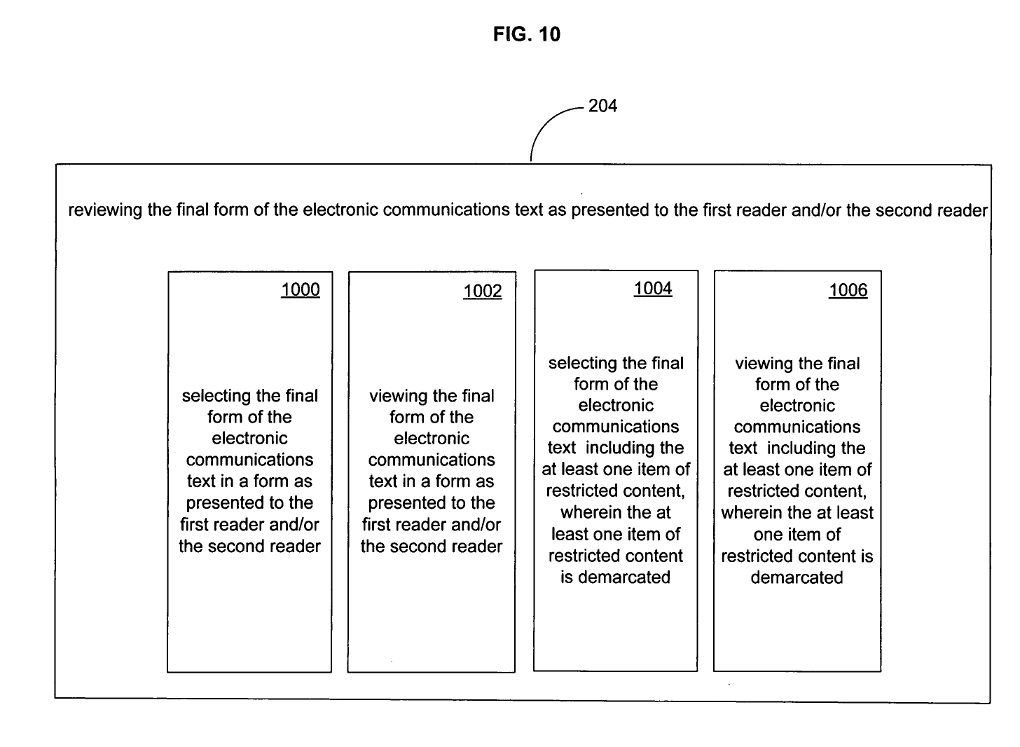

FIG. 10 shows several alternative implementations of the high-level logic flowchart of FIG. 2. Depicted is that operation 204—reviewing the final form of the electronic communications text as presented to the first reader and/or the second reader—may include one or more of the following operations: 1000, 1002, 1004, and/or 1006. Operation 1000 illustrates selecting the final form of the electronic communications text in a form as presented to the first reader and/or the second reader (e.g., selecting the final form of the electronic communications text in a form as presented to the first reader and/or the second reader, where the selecting is performed by the person 102 and/or the reviewer 114 using the hardware/software/firmware of computers 106 and/or 112, in the form in which the target reader was intended to see it, by choosing an option from a menu). Operation 1002 depicts viewing the final form of the electronic communications text in a form as presented to the first reader and/or the second reader (e.g., viewing the final form of the electronic communications text in a form as presented to the first reader and/or the second reader, where the viewing is performed by the person 102 and/or the reviewer 114 using the hardware/software/firmware of computers 106 and/or 112, in the form in which the target reader was intended to see it, by choosing an option from a menu). Operation 1004 depicts selecting the final form of the electronic communications text including the at least one item of restricted content, wherein the at least one item of restricted content is demarcated (e.g., selecting the final form of the electronic communications text including the at least one item of restricted content, wherein the at least one item of restricted content is demarcated, where the selecting is performed by the person 102 and/or the reviewer 114 using the hardware/software/firmware of computers 106 and/or 112, in the form in which the at least one item of restricted content which might otherwise be hidden is detectable to the person 102 and/or the reviewer 114, by choosing an option from a menu). Operation 1006 shows viewing the final form of the electronic communications text including the at least one item of restricted content, wherein the at least one item of restricted content is demarcated (e.g., viewing the final form of the electronic communications text including the at least one item of restricted content, wherein the at least one item of restricted content is demarcated, where the viewing is performed by the person 102 and/or the reviewer 114 using the hardware/software/firmware of computers 106 and/or 112, in the form in which the at least one item of restricted content which might otherwise be hidden is detectable to the person 102 and/or the reviewer 114, by choosing an option from a menu).

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

We claim:

1. A method related to electronic communications, the method comprising:
accepting input for preparing an electronic communications text, wherein the electronic communications text includes at least one item of restricted content to be hidden from a first reader of the electronic communications text and not hidden from a second reader of the electronic communications text; and
presenting the electronic communications text to the first reader and/or the second reader.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. A system related to electronic
communications, the system comprising:
means for accepting input for preparing an electronic communications text, wherein the electronic communications text includes at least one item of restricted content to be hidden from a first reader of the electronic communications text and not hidden from a second reader of the electronic communications text; and
means for presenting the electronic communications text to the first reader and/or the second reader.

39. The system of claim 38, further comprising:
means for accepting input representative of a reviewing manipulation of the final form of the electronic communications text as presented to the first reader and/or the second reader.

40. A program product, comprising:
a signal-bearing medium bearing
one or more instructions for accepting input for preparing an electronic communications text, wherein the electronic communications text includes at least one item of restricted content to be hidden from a first reader of the electronic communications text and not hidden from a second reader of the electronic communications text; and
one or more instructions for presenting the electronic communications text to the first reader and/or the second reader.

41. (canceled)

42. (canceled)

43. The program product of claim 40, wherein the one or more instructions for accepting input for preparing an electronic communications text, wherein the electronic communications text includes at least one item of restricted content to be hidden from a first reader of the electronic communications text and not hidden from a second reader of the electronic communications text further comprise:
one or more instructions for accepting input for demarcating the at least one item of restricted content.

44. The program product of claim 43, wherein the one or more instructions for accepting input for demarcating the at least one item of restricted content further comprise:
one or more instructions for accepting input from a use of a mechanical interface.

45. The program product of claim 44, wherein the one or more instructions for accepting further comprise:
one or more instructions for accepting input from a use of a keyboard.

46. The program product of claim 44, wherein the one or more instructions for accepting input from a use of a mechanical interface further comprise:
one or more instructions for accepting input from a use of a mouse.

47. The program product of claim 44, wherein the one or more instructions for accepting input from a use of a mechanical interface further comprise:
one or more instructions for accepting input from a use of a touchpad.

48. The program product of claim 44, wherein the one or more instructions for accepting input from a use of a mechanical interface further comprise:
one or more instructions for accepting input from a use of a touch-sensitive visual display.

49. The program product of claim 43, wherein the one or more instructions for accepting input for demarcating the at least one item of restricted content further comprise:
one or more instructions for accepting input from a use of a sonic interface.

50. The program product of claim 49, wherein the one or more instructions for accepting input from a use of a sonic interface further comprise:
one or more instructions for accepting input representative of a user speaking into a microphone.

51. The program product of claim 49, wherein the one or more instructions for accepting input from a use of a sonic interface further comprise:
one or more instructions for accepting input representative of at least one spoken word to indicate the at least one item of restricted content.

52. The program product of claim 49, wherein the one or more instructions for accepting input from a use of a sonic interface further comprise:
one or more instructions for accepting input representative of at least one distinct voice pitch to indicate the at least one item of restricted content.

53. The program product of claim 49, wherein the one or more instructions for accepting input from a use of a sonic interface further comprise:
one or more instructions for accepting input representative of at least one distinct voice intensity to indicate the at least one item of restricted content.

54. The program product of claim 43, wherein the one or more instructions for accepting input for demarcating the at least one item of restricted content further comprise:
one or more instructions for accepting input from a use of a visual interface.

55. The program product of claim 54, wherein the one or more instructions for accepting further comprise:
one or more instructions for accepting input from a use of a display screen.

56. The program product of claim 54, wherein the one or more instructions for accepting input from a use of a visual interface further comprise:
one or more instructions for accepting input from a use of a distinct type font to indicate the at least one item of restricted content.

57. The program product of claim 54, wherein the one or more instructions for accepting input from a use of a visual interface further comprise:
one or more instructions for accepting input from a use of a distinct font color to indicate a demarcation.

58. The program product of claim 54, wherein the one or more instructions for accepting input from a use of a visual interface further comprise:
one or more instructions for accepting input from a use of a distinct color highlight to indicate the at least one item of restricted content.

59. The program product of claim 40, wherein the one or more instructions for accepting input for preparing an electronic communications text, wherein the electronic communications text includes at least one item of restricted content to be hidden from a first reader of the electronic communications text and not hidden from a second reader of the electronic communications text further comprise:
one or more instructions for accepting input representative of an insertion of an item of replacement material for the at least one item of restricted content to be hidden from the first reader.

60. The program product of claim 40, wherein the one or more instructions for accepting input for preparing an electronic communications text, wherein the electronic communications text includes at least one item of restricted content to be hidden from a first reader of the electronic communications text and not hidden from a second reader of the electronic communications text further comprise:
one or more instructions for accepting input representative of an alteration of the electronic communications text to conceal that the at least one item of restricted content is to be hidden from the first reader.

61. The program product of claim 40, wherein the one or more instructions for accepting input for preparing an electronic communications text, wherein the electronic communications text includes at least one item of restricted content to be hidden from a first reader of the electronic communications text and not hidden from a second reader of the electronic communications text further comprise:
one or more instructions for accepting input representative of an editing of a draft form of the electronic communications text.

62. The program product of claim 61, wherein the one or more instructions for accepting input representative of an editing of a draft form of the electronic communications text further comprise:
one or more instructions for accepting input representative of a selection of the draft form of the electronic communications text in a form to be seen by the first reader and/or the second reader.

63. The program product of claim 61, wherein the one or more instructions for accepting input representative of an editing of a draft form of the electronic communications text further comprise:
one or more instructions for accepting input representative of a viewing manipulation of the draft form of the electronic communications text in a form to be seen by the first reader and/or the second reader.

64. The program product of claim 61, wherein the one or more instructions for accepting input representative of an editing of a draft form of the electronic communications text further comprise:
one or more instructions for accepting input representative of a selection of the draft form of the electronic communications text including the at least one item of restricted content, wherein the at least one item of restricted content is demarcated.

65. The program product of claim 61, wherein the one or more instructions for accepting input representative of an editing of a draft form of the electronic communications text further comprise:
one or more instructions for accepting input representative of a viewing manipulation of the draft form of the electronic communications text including the at least one item of restricted content, wherein the at least one item of restricted content is demarcated.

66. The program product of claim 61, wherein the one or more instructions for accepting input representative of an editing of a draft form of the electronic communications text further comprise:
one or more instructions for accepting input representative of an alteration of the draft form of the electronic communications text.

67. The program product of claim 40, wherein the one or more instructions for presenting the electronic communications text to the first reader and/or the second reader further comprise:
one or more instructions for confirming an identification credential of a target reader with respect to an identification criterion for the first reader and/or for the second reader.

68. The program product of claim 40, wherein the one or more instructions for presenting the electronic communications text to the first reader and/or the second reader further comprise:
one or more instructions for removing the at least one item of restricted content from the electronic communications text.

69. The program product of claim 40, wherein the one or more instructions for presenting the electronic communications text to the first reader and/or the second reader further comprise:
one or more instructions for replacing the at least one item of restricted content in the electronic communications text with a replacement indicator.

70. The program product of claim 40, wherein the one or more instructions for presenting the electronic communications text to the first reader and/or the second reader further comprise:
one or more instructions for sending a final form of the electronic communications text to the first reader and/or the second reader.

71. The program product of claim 40, wherein the one or more instructions for presenting the electronic communications text to the first reader and/or the second reader further comprise:
one or more instructions for making the final form of the electronic communications text available to the first reader and/or the second reader.

72. The program product of claim 40, further comprising:
one or more instructions for accepting input representative of a reviewing manipulation of the final form of the electronic communications text as presented to the first reader and/or the second reader.

73. The program product of claim 72, wherein the one or more instructions for accepting input representative of a reviewing manipulation of the final form of the electronic communications text as presented to the first reader and/or the second reader further comprise:
one or more instructions for accepting input representative of a selection of the final form of the electronic communications text in a form as presented to the first reader and/or the second reader.

74. The program product of claim 72, wherein the one or more instructions for accepting input representative of a reviewing manipulation of the final form of the electronic communications text as presented to the first reader and/or the second reader further comprise:
one or more instructions for accepting input representative of a viewing manipulation of the final form of the electronic communications text in a form as presented to the first reader and/or the second reader.

75. The program product of claim 72, wherein the one or more instructions for accepting input representative of a reviewing manipulation of the final form of the electronic communications text as presented to the first reader and/or the second reader further comprise:
one or more instructions for accepting input representative of a selection of the final form of the electronic communications text including the at least one item of restricted content, wherein the at least one item of restricted content is demarcated.

76. The program product of claim 72, wherein the one or more instructions for accepting input representative of a reviewing manipulation of the final form of the electronic communications text as presented to the first reader and/or the second reader further comprise:
one or more instructions for accepting input representative of a viewing manipulation of the final form of the electronic communications text including the at least one item of restricted content, wherein the at least one item of restricted content is demarcated.
